(19) United States
(12) Patent Application Publication
(10) Pub. No.: US 2022/0207671 A1
(43) Pub. Date: Jun. 30, 2022

(54) CONVERSION OF IMAGE

(71) Applicant: Shanghai Bilibili Technology Co., Ltd., Shanghai (CN)

(72) Inventor: Yi WANG, Shanghai (CN)

(73) Assignee: Shanghai Bilibili Technology Co., Ltd., Shanghai (CN)

(21) Appl. No.: 17/556,595

(22) Filed: Dec. 20, 2021

(30) Foreign Application Priority Data
Dec. 24, 2020 (CN) 202011548056.2

(51) Int. Cl. G06T 5/00; G06T 5/50

(52) U.S. Cl. CPC G06T 5/009; G06T 5/006; G06T 5/50; G06T 2207/20084; G06T 2207/20208; G06T 2207/20081; G06T 2207/10016

(57) ABSTRACT

A computer-implemented method is provided that includes: collecting a first-format sample image and a second-format sample image obtained by shooting a same scene as a sample image pair; inputting the first-format sample image and the second-format sample image of a plurality of sample image pairs into a deep learning model for training with samples to obtain an optimized model; and inputting a first-format image to be converted into the optimized model for processing, and outputting a second-format image corresponding to the first-format image.

### CROSS-REFERENCE TO RELATED APPLICATION

The present application claims priority to Chinese patent application No. 202011548056.2, filed on Dec. 24, 2020, the entire contents of which are hereby incorporated by reference in their entirety for all purposes.

### TECHNICAL FIELD

The present application relates to image processing, and particularly to conversion of image.

### BACKGROUND

Nowadays, more and more content producers are using High Dynamic Range (HDR) images to produce their works.

It should be noted that the above content is not used to limit the scope of protection of the present application.

### SUMMARY

One aspect of the present application provides a computer-implemented method that includes: collecting a first-format sample image and a second-format sample image obtained by shooting a same scene as a sample image pair; inputting the first-format sample image and the second-format sample image of a plurality of sample image pairs into a deep learning model for training with samples to obtain an optimized model; and inputting a first-format image to be converted into the optimized model for processing, and outputting a second-format image corresponding to the first-format image.

One aspect of the present application provides an electronic apparatus that includes: one or more processors; and a memory storing one or more programs configured to be executed by the one or more processors, the one or more programs including instructions for: collecting a first-format sample image and a second-format sample image obtained by shooting a same scene as a sample image pair; inputting the first-format sample image and the second-format sample image of a plurality of sample image pairs into a deep learning model for training with samples to obtain an optimized model; and inputting a first-format image to be converted into the optimized model for processing, and outputting a second-format image corresponding to the first-format image.

One aspect of the present application provides a non-transitory computer-readable storage medium storing one or more programs including instructions that, when executed by one or more processors of an electronic apparatus, cause the electronic apparatus to perform operations including: collecting a first-format sample image and a second-format sample image obtained by shooting a same scene as a sample image pair; inputting the first-format sample image and the second-format sample image of a plurality of sample image pairs into a deep learning model for training with samples to obtain an optimized model; and inputting a first-format image to be converted into the optimized model for processing, and outputting a second-format image corresponding to the first-format image.

### BRIEF DESCRIPTION OF THE DRAWINGS

FIG. 1 is an architecture diagram of an application environment for implementing various embodiments of the present application;

FIG. 2 is a schematic flowchart of a method of converting image according to some embodiments of the present application;

FIG. 3 is a schematic flowchart of a method of converting image according to some embodiments of the present application;

FIG. 4 is a detailed schematic flowchart of step S304 in FIG. 3;

FIG. 5 is a schematic flowchart of another form of model training stage according to the present application;

FIG. 6 is a schematic diagram of a hardware architecture of an electronic apparatus according to some embodiments of the present application;

FIG. 7 is a schematic diagram of means of a system of converting image according to some embodiments of the present application; and

FIG. 8 is a schematic diagram of means of a system of converting image according to some embodiments of the present application.

### DETAILED DESCRIPTION

In order to make the embodiments and advantages of the present application clearer, the present application will be described in further detail below in conjunction with the accompanying drawings and embodiments. It should be understood that the specific embodiments described here are merely intended to explain the present application, but are not intended to limit the present application. All other embodiments obtained by those of ordinary skill in the art based on the embodiments of the present application without creative efforts shall fall within the scope of protection of the present application.

It should be noted that the descriptions related to “first”, “second”, etc. in the embodiments of the present application are merely used for the illustrative purpose, and should not be construed as indicating or implying the relative importance thereof or implicitly indicating the number of technical features indicated. Thus, features defined with “first” and “second” may explicitly or implicitly include at least one of the features. Additionally, technical solutions among various embodiments can be combined with each other, but they must be based on the realization by those of ordinary skill in the art. When a combination of technical solutions is contradictory or cannot be realized, it should be considered that such a combination of the technical solutions does not exist, and also does not fall within the scope of protection of the present application claimed.

Nowadays, more and more content producers are using High Dynamic Range (HDR) images to produce their works. However, because the HDR technology emerges late and currently, HDR display devices are expensive, the market is still flooded with a large number of display devices that only support Standard Dynamic Range (SDR) images, and if these devices directly display HDR content, a large number of picture colors and details will be lost, and the users' experience will be poor.

Therefore, in practice, many devices map the HDR content to the color range of an SDR through a specific tone mapping algorithm, and then display it in the SDR. However, traditional tone mapping algorithm is based on a specific fixed pixel mapping relationship, for example, a fixed pixel value of an SDR image can be obtained from a pixel value of an HDR image via a series of calculations, regardless of the location of the pixel and its surroundings. This method can result in a very poor mapping effect in some scenes. Alternatively, producers can manually map HDR content to SDR to meet their own producing needs. However, this method loses the original intent for producers in producing using HDR and requires additional labor and effort, incurring additional producing costs.

In view of this, the present application provides a method, an electronic apparatus, and a computer-readable storage medium for converting image. According to the method, the electronic apparatus, and the computer-readable storage medium, the problem of how to automatically convert an HDR image to an SDR image and ensure the mapping effects can be solved.

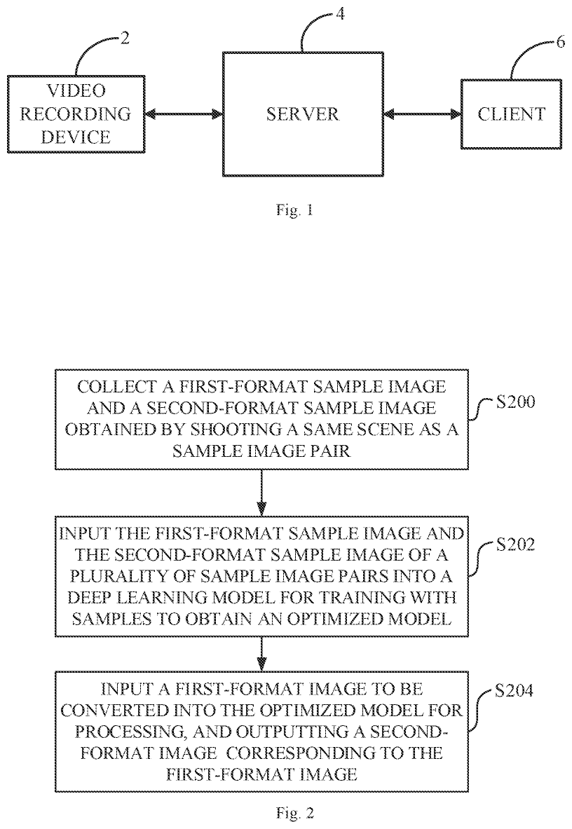

Referring to FIG. 1, FIG. 1 is an architecture diagram of an application environment for implementing various embodiments of the present application. The present application may be applied to an application environment including, but not limited to, a video recording device 2, a server 4, and a client 6.

The video recording device 2 is configured to shoot the same scene to obtain an HDR sample image and an SDR sample image. The video recording device 2 can be either two video recording devices with an HDR shooting capability and an SDR shooting capability respectively, which shoot the same scene at the same time to respectively obtain the HDR sample image and the SDR sample image, or one video recording device with both HDR and SDR video recording capabilities, which respectively shoots the same scene in an HDR mode and in an SDR mode to obtain the HDR sample image and the SDR sample image.

The server 4 is configured to train and optimize the deep learning model based on the HDR sample image and the SDR sample image obtained by shooting the same scene by the video recording device 2, so that the optimized model can automatically convert the input HDR image to obtain the corresponding SDR image. The server 4 may be a computing device such as a rack server, a blade server, a tower server, or a cabinet server, may be an independent server, or may be a server cluster composed of a plurality of servers.

The client 6 is configured to receive an HDR image to be converted and display a corresponding SDR image output by the model, and so on. The client 2 may be a terminal device such as a Personal Computer (PC), a mobile phone, a tablet computer, a portable computer, and a wearable device.

The server 4, one or more video recording devices 2, and the client 6 are communicatively connected through a wired or wireless network for data transmission and exchange. The network may be Intranet, Internet, the Global System for Mobile communications (GSM), Wideband Code Division Multiple Access (WCDMA), a 4G network, a 5G network, Bluetooth. or Wi-Fi.

FIG. 2 is a flowchart of a method of converting image according to some embodiments of the present application. It can be understood that the flowchart is not used to limit the executing order of the steps. Some of the steps in the flowchart can also be added or deleted as required.

The method includes the following steps.

S200, collecting a first-format sample image and a second-format sample image obtained by shooting a same scene as a sample image pair.

According to some embodiments, the first-format sample image is an HDR image, and the second-format sample image is an SDR image.

The method of converting image proposed in the embodiments is mainly divided into two stages: the first stage is a model training stage, and the second stage is a model applying stage. In the model training stage, the main purpose is to collect samples required for model training. Generally, image-related deep learning model training requires input of feature images and corresponding label images. According to some embodiments, the HDR sample image is used as a feature image input during model training, and the SDR sample image is used as a label image input during model training. SDR is a traditional digital image technology with weak color representation and susceptibility to lose details due to the limitations of the technology itself. HDR is a newer digital image technology than SDR, and is used to display a wider range of brightness and colors, to obtain more real colors.

Specifically, each time the same scene is shot by using a video recording device with HDR and SDR shooting capabilities, the HDR sample image and the SDR sample image are obtained as a sample image pair.

It should be noted that, the using a video recording device with HDR and SDR shooting capabilities can be either using two video recording devices with an HDR shooting capability and an SDR shooting capability respectively, which shoot the same scene at the same time to respectively obtain the HDR sample image and the SDR sample image, or using one video recording device with both HDR and SDR video recording capabilities, which respectively shoots the same scene in an HDR mode and in an SDR mode to obtain the HDR sample image and the SDR sample image.

S202, inputting the first-format sample image and the second-format sample image of a plurality of sample image pairs into a deep learning model for training with samples to obtain an optimized model.

By taking a plurality of shots of a plurality of scenes in the manner in the previous step, a large number of sample image pairs can be obtained and used to train the initial deep learning model. The deep learning model may be any feasible Convolutional Neural Network (CNN) model. In the deep learning model, the HDR sample image in each of the sample image pairs is used as a feature image, the corresponding SDR sample image is used as a label image, and the deep learning model is trained with a large number of sample image pairs and the deep learning model is optimized to learn a mapping relationship between the HDR sample image and the SDR sample image, so that the optimized model can automatically obtain a corresponding SDR image based on an HDR image. The specific process of training the deep learning model with a large number of samples can be done in a common method of training a deep learning model, which will not be repeated here.

S204, inputting a first-format image to be converted into the optimized model for processing, and outputting a second-format image corresponding to the first-format image.

In the process of producing or processing a video image, the optimized model is used as a video filter to process HDR image, and converts HDR pixels obtained through decoding to SDR pixels to obtain the corresponding SDR image. Specifically, when an HDR image needs to be transcoded, the HDR image to be converted is input into the trained optimized model for processing, and the optimized model directly outputs the corresponding SDR image after a series of calculations.

According to the method of converting image proposed in the above embodiments, it is possible to automatically convert an HDR image to an SDR image based on deep learning at a low cost. Since this method uses real sample image pairs to train deep learning models, and such models are often based on CNN networks, which take into account the impact of the scene itself on the conversion of HDR images to SDR images, this can achieve much better effects than traditional tone mapping algorithms. Also, in the method, image conversion is automatically completed on a computer, without additional labor and effort of the producer himself/herself.

It should be noted that, in the above embodiments, an example of converting an HDR image to an SDR image is used to describe the method of converting image. In other embodiments, it is also possible to train a model for images of other formats in a similar method as described above, and automatically convert the first-format sample image to the second-format sample image by the trained model.

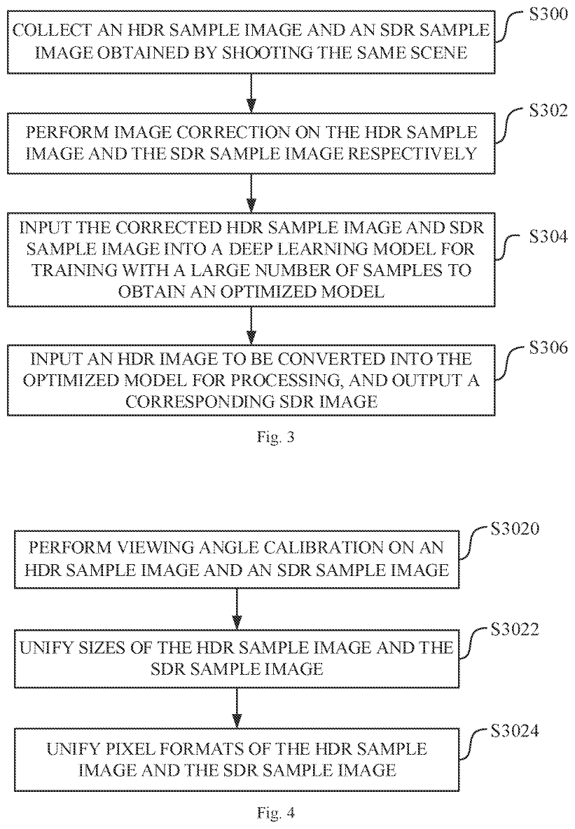

FIG. 3 is a flowchart of a method of converting image according to some embodiments of the present application. In these embodiments, on the basis of the above-mentioned embodiments, the method of converting image further includes steps of: performing image correction on the first-format sample image and the second-format sample image respectively. The first-format sample image may be an HDR sample image, and the second-format sample image may be an SDR sample image. FIG. 3 is a flowchart of a method of converting image taking the HDR sample image as the first-format sample image and the SDR sample image as the second-format sample image. It can be understood that the flowchart is not used to limit the executing order of the steps. Some of the steps in the flowchart can also be added or deleted as required.

The method includes the following steps.

S300, collecting an HDR sample image (i.e., the first-format sample image) and an SDR sample image (i.e., the second-format sample image) obtained by shooting the same scene.

The method of converting image proposed in the embodiments is mainly divided into two stages: the first stage is a model training stage, and the second stage is a model applying stage. In the model training stage, the main purpose is to collect samples required for model training. Generally, image-related deep learning model training requires input of feature images and corresponding label images. According to some embodiments, the HDR sample image is used as a feature image input during model training, and the SDR sample image is used as a label image input during model training. SDR is a traditional digital image technology with weak color representation and susceptibility to lose details due to the limitations of the technology itself. HDR is a newer digital image technology than SDR, and is used to display a wider range of brightness and colors, to obtain more real colors.

Specifically, each time the same scene is shot by using a video recording device with HDR and SDR shooting capabilities, the HDR sample image and the SDR sample image are obtained as a sample image pair.

It should be noted that, the using a video recording device with HDR and SDR shooting capabilities can be either using two video recording devices with an HDR shooting capability and an SDR shooting capability respectively, which shoot the same scene at the same time to respectively obtain the HDR sample image and the SDR sample image, or using one video recording device with both HDR and SDR video recording capabilities, which respectively shoots the same scene in an HDR mode and in an SDR mode to obtain the HDR sample image and the SDR sample image.

S302, performing image correction on the HDR sample image and the SDR sample image respectively.

According to some embodiments, the image correction includes, but is not limited to: viewing angle calibration, image size unification, and pixel format unification. With the image correction, the viewing angles of the HDR sample image and the SDR sample image are consistent, and the image sizes thereof and pixel formats thereof are the same.

Specifically, further refer to FIG. 4, which is a detailed schematic flowchart of step S302. It can be understood that the flowchart is not used to limit the executing order of the steps. Some of the steps in the flowchart can also be added or deleted as required. According to some embodiments, step S302 specifically includes:

S3020, performing viewing angle calibration on the HDR sample image and the SDR sample image.

In the case of taking shots using two video recording devices with an HDR shooting capability and an SDR shooting capability respectively, the images obtained by the lenses of the two video recording devices may be slightly different due to the difference in the positions of the two video recording devices. Therefore, it is required to add a process of viewing angle calibration. The viewing angle calibration refers to calculating a viewing angle difference between the HDR sample image and the SDR sample image obtained by the two video recording devices respectively, and correcting the viewing angle difference to make the HDR sample image and the SDR sample image to be images captured at the same viewing angle. According to some embodiments, any feasible binocular vision algorithm can be used to implement the viewing angle calibration, such that the viewing angles of the HDR sample image and the SDR sample image are consistent. Specific calibration methods will not be repeated here.

The purpose of the viewing angle calibration is to align images captured by two video recording devices as much as possible, so as to resolve the slight difference between the viewing angles. Theoretically, if the video recording devices themselves are not large, the difference between the viewing angles is very small, and it is possible to do without viewing angle calibration. Therefore, in other embodiments, this step may alternatively be omitted.

S3022, unifying sizes of the HDR sample image and the SDR sample image.

In order to ensure the effect of model training and improve its accuracy, it is also required to unify the sizes of the HDR sample image and the SDR sample image (after the viewing angle calibration). According to some embodiments, any image scaling algorithm can be used to unify the image sizes, such as bicubic interpolation algorithm, Lanczos interpolation algorithm, etc. Through the above-mentioned image scaling algorithm, the sizes of the HDR sample image and the SDR sample image are both scaled to a preset fixed value. The preset fixed value can be set according to actual application scenarios.

S3024, unifying pixel formats of the HDR sample image and the SDR sample image.

In addition to viewing angle calibration and image size unification, the pixel formats of the HDR sample image and the SDR sample image also need to be unified, so that the model can better learn a mapping relationship between the HDR sample image and the SDR sample image.

According to some embodiments, the pixel formats of the HDR sample image and the SDR sample image can be unified to the same bits, for example, the color depths thereof are unified to 16 bits, that is, each of the three colors RGB is represented by a 16-bit integer. Specifically, the extension to 16 bits can be achieved by directly filling in the high bits of each 8-bit or 10-bit color with 0. Certainly, in other embodiments, any other feasible manners can also be used to achieve the pixel format unification of the images, which will not be repeated here.

Referring back to FIG. 3, in S304, inputting the corrected HDR sample image and SDR sample image into a deep learning model for training with a large number of samples to obtain an optimized model.

By taking a plurality of shots of a plurality of scenes in the manner in step S300, a large number of sample image pairs can be obtained, and these sample image pairs can be used to train the initial deep learning model after being corrected in step S302. In the deep learning model, the (corrected) HDR sample image in each of the sample image pairs is used as a feature image, the corresponding (corrected) SDR sample image is used as a label image, and the deep learning model is trained with a large number of sample image pairs and the deep learning model is optimized to learn a mapping relationship between the HDR sample image and the SDR sample image, so that the optimized model can automatically obtain a corresponding SDR image based on an HDR image. The specific process of training the deep learning model with a large number of samples can be done in a common method of training a deep learning model, which will not be repeated here.

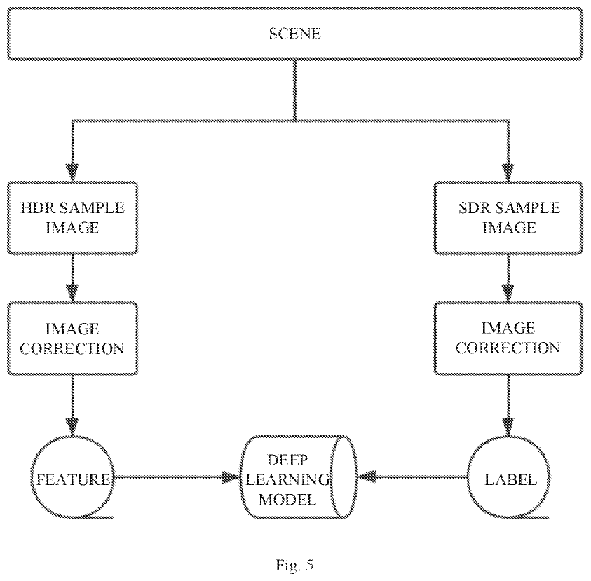

Further refer to FIG. 5, which is a schematic flowchart of another form of model training stage according to some embodiments. In FIG. 5, first, the same scene is shot by using a video recording device with HDR and SDR shooting capabilities to obtain the HDR sample image and the SDR sample image. Then, image correction is respectively performed on the HDR sample image and the SDR sample image, and the corrected HDR sample image is used as a feature image and the corrected SDR sample image is used as a label image, and the two are input into the deep learning model for training. The trained optimized model can be obtained through training with a large number of samples according to the above process.

Referring back to FIG. 3, in S306, inputting an HDR image to be converted into the optimized model for processing, and outputting a corresponding SDR image.

In the process of producing or processing a video image, the optimized model is used as a video filter to process HDR image, and converts HDR pixels obtained through decoding to SDR pixels to obtain the corresponding SDR image. Specifically, when an HDR image needs to be transcoded, the HDR image to be converted is input into the trained optimized model for processing, and the optimized model directly outputs the corresponding SDR image after a series of calculations.

According to the method of converting image proposed in the above embodiments, it is possible to automatically convert an HDR image to an SDR image based on deep learning at a low cost. Since this method uses real sample image pairs to train deep learning models, and such models are often based on CNN networks, which take into account the impact of the scene itself on the conversion of HDR images to SDR images, this can achieve much better effects than traditional tone mapping algorithms. Also, in the method, image conversion is automatically completed on a computer, without additional labor and effort of the producer himself/herself. In addition, before the model training, corrections such as viewing angle calibration, image size unification, and pixel format unification are performed on an HDR sample image and an SDR sample image respectively, which can unify various aspects of the HDR sample image and the SDR sample image, so that the deep learning model can better learn a mapping relationship between the HDR sample image and the SDR sample image, ensuring the effect of model training, and improving the accuracy of model output results.

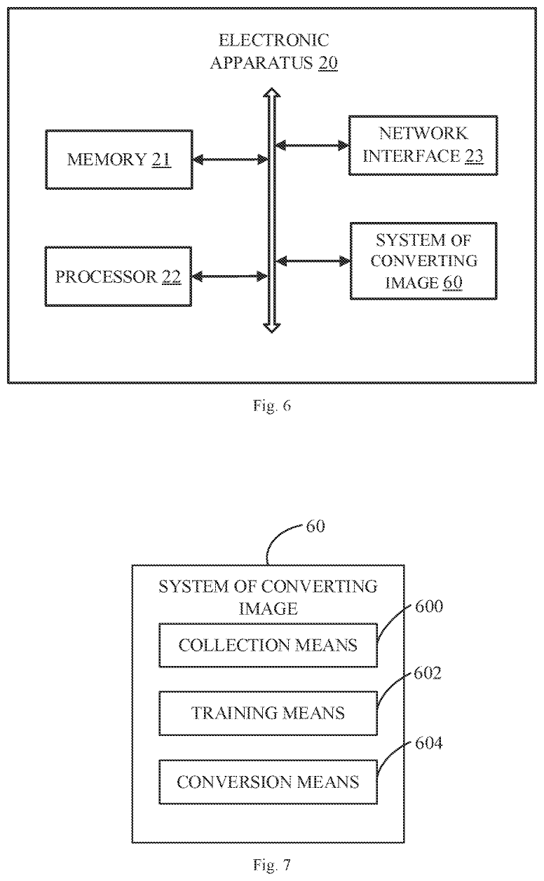

FIG. 6 is a schematic diagram of a hardware architecture of an electronic apparatus 20 according to some embodiments of the present application. According to some embodiments, the electronic apparatus 20 may include, but is not limited to, a memory 21, a processor 22, and a network interface 23 that can be communicatively connected to each other via a system bus. It should be noted that FIG. 6 shows only the electronic apparatus 20 having components 21 to 23, but it should be understood that not all of the illustrated components are required to be implemented, and more or fewer components may be implemented instead. According to some embodiments, the electronic apparatus 20 may be the server 4.

The memory 21 includes at least one type of readable storage medium, and the readable storage medium includes a flash memory, a hard disk, a multimedia card, a card-type memory (e.g., an SD or DX memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, etc. In some embodiments, the memory 21 may be an internal storage unit of the electronic apparatus 20, such as a hard disk or a memory of the electronic apparatus 20. In some other embodiments, the memory 21 may alternatively be an external storage device of the electronic apparatus 20, such as a plug-in hard disk disposed on the electronic apparatus 20, a smart media card (SMC), a secure digital (SD) card, and a flash card. Certainly, the memory 21 may alternatively include both the internal storage unit of the electronic apparatus 20 and the external storage device thereof. According to some embodiments, the memory 21 is generally configured to store an operating system and various application software installed in the electronic apparatus 20, such as program codes of a system of converting image 60. In addition, the memory 21 may be further configured to temporarily store various types of data that has been output or will be output.

The processor 22 may be, in some embodiments, a central processing unit (CPU), a controller, a microcontroller, a microprocessor, or other data processing chips. The processor 22 is generally configured to control the overall operation of the electronic apparatus 20. According to some embodiments, the processor 22 is configured to run program codes stored in the memory 21 or to process data, such as running the system of converting image 60.

The network interface 23 may include a wireless network interface or a wired network interface, and the network interface 23 is generally configured to establish a communication connection between the electronic apparatus 20 and other electronic devices.

When a program stored in the memory 21 of the electronic apparatus 20 is executed by the processor 22, the method of converting image described in the above-mentioned embodiments can be implemented.

FIG. 7 is a schematic diagram of modules of a system of converting image 60 according to some embodiments of the present application. The system of converting image 60 may be divided into one or more program modules, and the one or more program modules are stored in a storage medium and executed by one or more processors to implement the embodiments of the present application. The program modules referred to in the embodiments of the present application refer to a series of computer program instruction segments that can complete a specific function. The functions of various program modules according to some embodiments will be specifically explained in the following description.

According to some embodiments, the system of converting image 60 includes:

a collection means 600 configured to collect an HDR sample image and an SDR sample image obtained by shooting the same scene.

The processing process of the system of converting image proposed in the embodiments is mainly divided into two stages: the first stage is a model training stage, and the second stage is a model applying stage. In the model training stage, the main purpose is to collect samples required for model training. Generally, image-related deep learning model training requires input of feature images and corresponding label images. According to some embodiments, the HDR sample image is used as a feature image input during model training, and the SDR sample image is used as a label image input during model training. SDR is a traditional digital image technology with weak color representation and susceptibility to lose details due to the limitations of the technology itself. HDR is a newer digital image technology than SDR, and is used to display a wider range of brightness and colors, to obtain more real colors.

Specifically, each time the same scene is shot by using a video recording device 2 with HDR and SDR shooting capabilities, the HDR sample image and the SDR sample image are obtained as a sample image pair.

It should be noted that, the using a video recording device 2 with HDR and SDR shooting capabilities can be either using two video recording devices 2 with an HDR shooting capability and an SDR shooting capability respectively, which shoot the same scene at the same time to respectively obtain the HDR sample image and the SDR sample image, or using one video recording device 2 with both HDR and SDR video recording capabilities, which respectively shoots the same scene in an HDR mode and in an SDR mode to obtain the HDR sample image and the SDR sample image.

The collection means 600 acquires the HDR sample image and the SDR sample image from one or two of the video recording devices 2.

The system of converting image includes a training means 602 configured to input the HDR sample image and the SDR sample image into a deep learning model for training with a large number of samples to obtain an optimized model.

By taking a plurality of shots of a plurality of scenes in the manner described above, a large number of sample image pairs can be obtained and used to train the initial deep learning model. The deep learning model may be any feasible CNN model. In the deep learning model, the HDR sample image in each of the sample image pairs is used as a feature image, the corresponding SDR sample image is used as a label image, and the deep learning model is trained with a large number of sample image pairs and the deep learning model is optimized to learn a mapping relationship between the HDR sample image and the SDR sample image, so that the optimized model can automatically obtain a corresponding SDR image based on an HDR image. The specific process of training the deep learning model with a large number of samples can be done in a common method of training a deep learning model, which will not be repeated here.

The system of converting image includes a conversion means 604 configured to input an HDR image to be converted into the optimized model for processing, and output a corresponding SDR image.

In the process of producing or processing a video image, the optimized model is used as a video filter to process HDR image, and converts HDR pixels obtained through decoding to SDR pixels to obtain the corresponding SDR image. Specifically, when an HDR image needs to be transcoded, the HDR image to be converted is input into the trained optimized model for processing, and the optimized model directly outputs the corresponding SDR image after a series of calculations.

According to the system of converting image proposed in the embodiments, it is possible to automatically convert an HDR image to an SDR image based on deep learning at a low cost. Since this system uses real sample image pairs to train deep learning models, and such models are often based on CNN networks, which take into account the impact of the scene itself on the conversion of HDR images to SDR images, this can achieve much better effects than traditional tone mapping algorithms. Also, the system automatically completes image conversion on a computer, without additional labor and effort of the producer himself/herself.

It should be noted that, in the above embodiments, an example of converting an HDR image to an SDR image is used to describe the system of converting image. In other embodiments, it is also possible to train a model for images of other formats in a similar processing process as described above, and automatically convert the first-format sample image to the second-format sample image by the trained model.

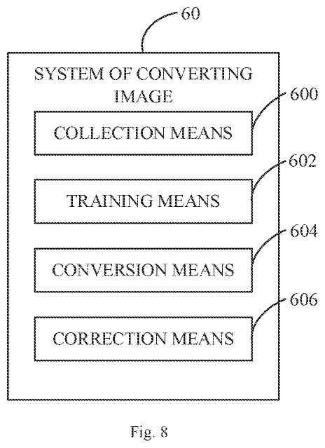

FIG. 8 is a schematic diagram of modules of a system of converting image 60 according to some embodiments of the present application. According to some embodiments, the system of converting image 60 includes a correction means 606 in addition to the collection means 600, the training means 602, and the conversion means 604 in the embodiments described above.

The correction means 606 is configured to perform image correction on the HDR sample image and the SDR sample image respectively before the two are input into the deep training model.

According to some embodiments, the image correction includes, but is not limited to, viewing angle calibration, image size unification, and pixel format unification. With the image correction, the viewing angles of the HDR sample image and the SDR sample image are consistent, and the image sizes thereof and pixel formats thereof are the same.

Specifically, the process may include:

(1) Performing Viewing Angle Calibration on the HDR Sample Image and the SDR Sample Image.

In the case of taking shots using two video recording devices 2 with an HDR shooting capability and an SDR shooting capability respectively, the images obtained by the lenses of the two video recording devices 2 may be slightly different due to the differences in the positions of the two video recording devices 2. Therefore, it is required to add a process of viewing angle calibration. The viewing angle calibration refers to calculating a viewing angle difference between the HDR sample image and the SDR sample image obtained by the two video recording devices 2 respectively, and correcting the viewing angle difference to make the HDR sample image and the SDR sample image to be images captured at the same viewing angle. According to some embodiments, any feasible binocular vision algorithm can be used to implement the viewing angle calibration, such that the viewing angles of the HDR sample image and the SDR sample image are consistent. Specific calibration methods will not be repeated here.

The purpose of the viewing angle calibration is to align images captured by two lenses as much as possible, so as to resolve the slight difference between the viewing angles. Theoretically, if the cameras themselves are not large, the difference between the viewing angles is very small, and it is possible to do without correction. Therefore, in other embodiments, this step may alternatively be omitted.

(2) Unifying Sizes of the HDR Sample Image and the SDR Sample Image.

In order to ensure the effect of model training and improve its accuracy, it is also required to unify the sizes of the HDR sample image and the SDR sample image (after the viewing angle calibration). According to some embodiments, any image scaling algorithm can be used to unify the image sizes, such as bicubic interpolation algorithm, Lanczos interpolation algorithm, etc. Through the above-mentioned image scaling algorithm, the sizes of the HDR sample image and the SDR sample image are both scaled to a preset fixed value. The preset fixed value can be set according to actual application scenarios.

(3) Unifying Pixel Formats of the HDR Sample Image and the SDR Sample Image.

In addition to viewing angle calibration and image size unification, the pixel formats of the HDR sample image and the SDR sample image also need to be unified, so that the model can better learn a mapping relationship between the HDR sample image and the SDR sample image. According to some embodiments, the pixel formats of the HDR sample image and the SDR sample image can be unified to the same bits, for example, the color depths thereof are unified to 16 bits, that is, each of the three colors RGB is represented by a 16-bit integer. Specifically, the extension to 16 bits can be achieved by directly filling in the high bits of each 8-bit or 10-bit color with 0. Certainly, in other embodiments, any other feasible manners can also be used to achieve the pixel format unification of the images, which will not be repeated here.

According to the system of converting image proposed in the above embodiments, before the model training, corrections such as viewing angle calibration, image size unification, and pixel format unification are performed on an HDR sample image and an SDR sample image respectively, which can unify various aspects of the HDR sample image and the SDR sample image, so that the deep learning model can better learn a mapping relationship between the HDR sample image and the SDR sample image, ensuring the effect of model training, and improving the accuracy of model output results.

The present application further provides another implementation, i.e., providing a non-transitory computer-readable storage medium storing a program for converting image, which, when executed by at least one processor, causes the at least one processor to implement the steps of the method of converting image as described above.

It should be noted that in this application, terms “include”, “comprise” or any other variants thereof are intended to cover non-exclusive inclusion, so that a process, a method, an article or an apparatus that includes a series of elements not only includes those elements, but also includes other elements that are not explicitly listed, or includes inherent elements of the process, method, article, or apparatus. Without more restrictions, an element defined by the phrase “including a . . . ” does not exclude the presence of additional identical elements in the process, method, article, or apparatus that includes the element.

The serial numbers of the embodiments of the present application described above are merely for description, and do not indicate that the embodiments are good or bad.

It will be apparent to those skilled in the art that the various modules or steps in the embodiments of the present application can be implemented by a general-purpose computing device that can be centralized on a single computing device or distributed across a network formed by a plurality of computing devices. Optionally, they may be implemented by program codes executable by the computing device, such that they may be stored in a storage device and executed by the computing device, and in some cases, the steps shown or described may be performed in a sequence different from the sequence described herein, or they may be respectively fabricated into individual integrated circuit modules, or a plurality of modules or steps thereof may be implemented as a single integrated circuit module. In this way, the embodiments of the present application are not limited to any specific combination of hardware and software.

The foregoing descriptions are merely illustrations of the embodiments of the present application, and are not intended to limit the patent scope of the embodiments of the present application. Any equivalent structure or equivalent process transformation made using the contents of the specification and accompanying drawings of the embodiments of the present application, or any direct or indirect application thereof in other related technical fields shall equally fall within the patent protection scope of the embodiments of the present application.

What is claimed is:

1. A computer-implemented method, comprising:
collecting a first-format sample image and a second-format sample image obtained by shooting a same scene as a sample image pair;
inputting the first-format sample image and the second-format sample image of a plurality of sample image pairs into a deep learning model for training with samples to obtain an optimized model; and
inputting a first-format image to be converted into the optimized model for processing, and outputting a second-format image corresponding to the first-format image.

2. The method of claim 1, further comprising:
before inputting the first-format sample image and the second-format sample image into the deep learning model, performing image correction on the first-format sample image and the second-format sample image respectively.

3. The method of claim 1, wherein the first-format sample image is a High Dynamic Range (HDR) image, and the second-format sample image is a Standard Dynamic Range (SDR) image.

4. The method of claim 3, wherein the collecting a first-format sample image and a second-format sample image obtained by shooting the same scene comprises:
shooting the same scene at a same time using two video recording devices with an HDR shooting capability and an SDR shooting capability respectively, or shooting the same scene using one video recording device with both HDR and SDR shooting capabilities in an HDR mode and in an SDR mode respectively, to obtain an HDR sample image and an SDR sample image.

5. The method of claim 3, wherein the inputting the first-format sample image and the second-format sample image of a plurality of sample image pairs into a deep learning model for training with samples comprises:
using the HDR sample image in each of the sample image pairs as a feature image inputted into the deep learning model, using the SDR sample image as a label image inputted into the deep learning model, and training the deep learning model with the plurality of sample image pairs to learn a mapping relationship between the HDR sample image and the SDR sample image.

6. The method of claim 2, wherein the image correction comprises: viewing angle calibration, image size unification, and pixel format unification.

7. The method of claim 2, wherein the performing image correction on the first-format sample image and the second-format sample image respectively comprises:
performing viewing angle calibration on the first-format sample image and the second-format sample image using a binocular vision algorithm, such that viewing angles of the first-format sample image and the second-format sample image are consistent;
unifying sizes of the first-format sample image and the second-format sample image to a preset fixed value; and
unifying pixel formats of the first-format sample image and the second-format sample image to the same bits.

8. An electronic apparatus, comprising:
one or more processors; and
a memory storing one or more programs configured to be executed by the one or more processors, the one or more programs comprising instructions for:
collecting a first-format sample image and a second-format sample image obtained by shooting a same scene as a sample image pair;
inputting the first-format sample image and the second-format sample image of a plurality of sample image pairs into a deep learning model for training with samples to obtain an optimized model; and
inputting a first-format image to be converted into the optimized model for processing, and outputting a second-format image corresponding to the first-format image.

9. The electronic apparatus of claim 8, wherein the one or more programs further comprise instructions for:
before inputting the first-format sample image and the second-format sample image into the deep learning model, performing image correction on the first-format sample image and the second-format sample image respectively.

10. The electronic apparatus of claim 8, wherein the first-format sample image is a High Dynamic Range (HDR) image, and the second-format sample image is a Standard Dynamic Range (SDR) image.

11. The electronic apparatus of claim 10, wherein the collecting a first-format sample image and a second-format sample image obtained by shooting the same scene comprises:
shooting the same scene at a same time using two video recording devices with an HDR shooting capability and an SDR shooting capability respectively, or shooting the same scene using one video recording device with both HDR and SDR shooting capabilities in an HDR mode and in an SDR mode respectively, to obtain an HDR sample image and an SDR sample image.

12. The electronic apparatus of claim 10, wherein the inputting the first-format sample image and the second-format sample image of a plurality of sample image pairs into a deep learning model for training with samples comprises:
using the HDR sample image in each of the sample image pairs as a feature image inputted into the deep learning model, using the SDR sample image as a label image inputted into the deep learning model, and training the deep learning model with the plurality of sample image pairs to learn a mapping relationship between the HDR sample image and the SDR sample image.

13. The electronic apparatus of claim 9, wherein the image correction comprises: viewing angle calibration, image size unification, and pixel format unification.

14. The electronic apparatus of claim 9, wherein the performing image correction on the first-format sample image and the second-format sample image respectively comprises:
performing viewing angle calibration on the first-format sample image and the second-format sample image using a binocular vision algorithm, such that viewing angles of the first-format sample image and the second-format sample image are consistent;
unifying sizes of the first-format sample image and the second-format sample image to a preset fixed value, and
unifying pixel formats of the first-format sample image and the second-format sample image to the same bits.

15. A non-transitory computer-readable storage medium, storing one or more programs comprising instructions that, when executed by one or more processors of an electronic apparatus, cause the electronic apparatus to perform operations comprising:
collecting a first-format sample image and a second-format sample image obtained by shooting a same scene as a sample image pair;
inputting the first-format sample image and the second-format sample image of a plurality of sample image pairs into a deep learning model for training with samples to obtain an optimized model; and
inputting a first-format image to be converted into the optimized model for processing, and outputting a second-format image corresponding to the first-format image.

16. The non-transitory computer-readable storage medium of claim 15, wherein the operations further comprise:
before inputting the first-format sample image and the second-format sample image into the deep learning model, performing image correction on the first-format sample image and the second-format sample image respectively.

17. The non-transitory computer-readable storage medium of claim 15, wherein the first-format sample image is a High Dynamic Range (HDR) image, and the second-format sample image is a Standard Dynamic Range (SDR) image.

18. The non-transitory computer-readable storage medium of claim 17, wherein the collecting a first-format sample image and a second-format sample image obtained by shooting the same scene comprises:
shooting the same scene at a same time using two video recording devices with an HDR shooting capability and an SDR shooting capability respectively, or shooting the same scene using one video recording device with both HDR and SDR shooting capabilities in an HDR mode and in an SDR mode respectively, to obtain an HDR sample image and an SDR sample image.

19. The non-transitory computer-readable storage medium of claim 17, wherein the inputting the first-format sample image and the second-format sample image of a plurality of sample image pairs into a deep learning model for training with samples comprises:
using the HDR sample image in each of the sample image pairs as a feature image inputted into the deep learning model, using the SDR sample image as a label image inputted into the deep learning model, and training the deep learning model with the plurality of sample image pairs to learn a mapping relationship between the HDR sample image and the SDR sample image.

20. The non-transitory computer-readable storage medium of claim 16, wherein the image correction comprises: viewing angle calibration, image size unification, and pixel format unification.
